(19) United States
(12) Patent Application Publication
(10) Pub. No.: US 2018/0170124 A1
(43) Pub. Date: Jun. 21, 2018

(54) CONTROL VALVE ASSEMBLY

(71) Applicant: JAGUAR LAND ROVER LIMITED, Whitley, Coventry, Warwickshire (GB)

(72) Inventors: Maelle DODU, Leamington Spa, Warwickshire (GB); Emma-Claire DUNNING, Coventry, West Midlands (GB); Robbie LESBIREL, Leamington Spa, Warwickshire (GB)

(21) Appl. No.: 15/735,193

(22) PCT Filed: Jun. 9, 2016
(86) PCT No.: PCT/EP2016/063136

§ 371 Date: Dec. 10, 2017

(30) Foreign Application Priority Data
Jun. 10, 2015 (GB) 1510054.8

(51) Int. Cl. B60C 23/00; B29C 69/00; F16K 17/196; F16K 15/20

(52) U.S. Cl. CPC B60C 23/003; B29C 69/00; B29L 2031/7506; F16K 15/20; F16K 17/196

(57) ABSTRACT

A control valve assembly for use with a vehicle wheel assembly. The control valve assembly includes: an inlet for receiving compressed air from a supply line; an outlet for supplying compressed air to a transfer line; and a control valve for selectively placing the inlet in fluid communication with the outlet. The control valve assembly is configured to be removably disposed in a wheel hub. The control valve assembly also includes an annular cage mounted around the outlet. The annular cage supports a transfer line filter for filtering air moving between the control valve and the transfer line. The cage has a base ring and a secondary ring. The transfer line filter extends intermediate the base and secondary rings. The base and secondary rings each have a radial foot arranged to space the transfer line filter from the control valve assembly to provide an annular cavity therebetween.

### TECHNICAL FIELD

The present disclosure relates to a vehicle wheel assembly and in particular, but not exclusively, to a vehicle wheel assembly for delivering compressed air from a vehicle axle to a tire. Aspects of the present invention relate to a control valve assembly, an annular cage, a method of manufacturing, a housing, a Central Tire Inflation System (CTIS) and a vehicle.

### BACKGROUND

The present invention was conceived in the context of central tire inflation systems (CTIS). CTIS were originally developed for military applications, in particular off-road military wheeled trucks and trailers. However, CTIS are nowadays incorporated into non-military vehicles such as specialist construction, agricultural and commercial vehicles.

CTIS comprise one or more compressed air sources located on-board the vehicle in fluid communication with one or more tires. Tire pressure can therefore be adjusted by the CTIS. Typically, CTIS provide for delivery of compressed air to a tire through a hose connected to the wheel and in some cases, this is integrated into a vehicle axle. Accordingly, there are vehicle wheels and vehicle wheel assemblies designed to receive incoming flow of compressed air from the axle, and to deliver it to the tire.

U.S. Pat. No. 6,425,427 B1 discloses an on-axle tire inflation system.

US 2005/0236083 A1 discloses a vehicle wheel assembly comprising a rim secured to a wheel hub and a tire secured to the rim, with a hollow stud having an air conduit. The hollow stud extends through a rim opening and has a first end secured to the hub. A lug nut is secured to the hollow stud at a second end. The first end is operably connected to a source of compressed air through the air conduit. A central tire inflation valve is secured to the rim. The rim includes a first internal conduit communicating with the air conduit and the valve, and a second internal conduit communicating with the valve and the interior of the tire.

Drawbacks of the known systems include their adverse effect on wheel styling (which is not typically a concern with trucks but may not be aesthetically acceptable for passenger vehicles), their bulkiness and heaviness.

It is an object of the present invention to further improve on central tire inflation systems.

### SUMMARY OF THE INVENTION

Aspects and embodiments of the invention provide a control valve assembly, an annular cage, a method of manufacturing, a housing, a Central Tire Inflation System (CTIS)) and a vehicle.

According to one aspect of the present invention there is provided a control valve assembly for use with a vehicle wheel assembly, the control valve assembly comprising;

an inlet for receiving compressed air from a supply line;

an outlet for supplying compressed air to a transfer line;

a control valve for selectively placing the inlet in fluid communication with the outlet;

wherein the control valve assembly is configured to be removably disposed in a wheel hub; and

an annular cage mounted around the outlet, the annular cage supporting a transfer line filter for filtering air moving between the control valve and the transfer line, wherein the cage comprises a base ring and a secondary ring, the transfer line filter extending intermediate the base and secondary rings, wherein the base and secondary rings each comprise a radial foot arranged to space the transfer line filter from the control valve assembly to provide an annular cavity therebetween.

In the event that a part of the filter proximal to the outlet becomes blocked, air will be able to flow around the cavity to other parts of the filter so air flow through the control valve assembly is unaffected by the blockage.

In an embodiment, the cage comprises a plurality of axial spokes, and wherein the transfer line filter comprises a plurality of individual filter elements, wherein adjacent spokes are arranged to support a filter element therebetween. The spokes provide structural rigidity to the cage and the filter.

In an embodiment, the control valve assembly comprises a housing having an annular wall defining a chamber for housing a control valve, the outlet comprising a plurality of through-holes passing through the annular wall.

A plurality of through-holes, as opposed to a single through-hole, provides a degree of redundancy in case of a blockage in one of the through-holes.

In an embodiment, the through-holes are arranged to extend radially around a central axis of the control valve assembly.

In an embodiment, the through-holes are equiangularly spaced apart. An even through flow of air can thus be promoted through the control valve.

According to a further aspect of the present invention there is provided a control valve assembly for a vehicle wheel assembly, the control valve assembly comprising;
an inlet for receiving compressed air from a supply line;
an outlet for supplying compressed air to a transfer line;
a control valve for selectively placing the inlet in fluid communication with the outlet;
wherein the control valve assembly is configured to be removably disposed in a wheel hub;
wherein the control valve assembly comprises a filter for filtering air moving between the supply line and the transfer line; and
wherein the filter is coated with a hydrophobic material.

The hydrophobic material reduces the likelihood of any condensation from within the tire from flowing back into the supply line via the control valve assembly.

In an embodiment, the control valve assembly comprises a mounting formation and wherein the filter comprises a supply line filter for filtering air moving between the supply line and the control valve. Alternatively or in addition the control valve assembly may comprise an annular cage and the filter may comprise the transfer line filter supported by the annular cage. The annular cage may be mounted around the outlet, the annular cage supporting a transfer line filter for filtering air moving between the control valve and the transfer line, wherein the cage comprises a base ring and a secondary ring, the transfer line filter extending intermediate the base and secondary rings, wherein the base and secondary rings each comprise a radial foot arranged to space the transfer line filter from the control valve assembly to provide an annular cavity therebetween.

According to a further aspect of the present invention there is provided a method of manufacturing at least part of a housing for housing a control valve of a control valve assembly in a Central Tire Inflation System (CTIS) of a vehicle wheel assembly, the housing comprising a circumferential seal surface for receiving at least one O-ring thereon, an outwardly extending circumferential flange for axially constraining said at least one O-ring, the one or more O-ring arranged to seal hermetically the control valve assembly from a wheel hub within which the control valve assembly is removably mounted, the method comprising;
molding a first section of the part comprising said circumferential seal surface using a mold tool;
molding a second section of the part using an opposing mold tool; and
axially separating the opposing mold tool from the mold tool to provide a circumferential flash-line on the housing,
and wherein said circumferential seal surface is free of flash lines.

A circumferential flash-line, as opposed to an axially extending flash-line reduces wear on an O-ring and also prevents leakage between the wall and the O-rings.

In an embodiment, the method comprises arranging the mold tool and opposing mold tool to locate the flash-line on the flange. In this way, the flash-line completely avoids the O-ring, in-use.

In an embodiment, at least part of the housing is manufactured in modular form, comprising;
fabricating a first module using the aforementioned method;
fabricating a second module using the aforementioned method; and
attaching the first module to the second module to provide respective first and second circumferential flash-lines on the housing.

In an embodiment, first and second modules are attached by welding.

In an embodiment, welding comprises ultrasonic welding.

In an alternative or additional embodiment, molding the second section comprises;
providing a mold tool having a mold piece and an opposing mold piece;
contacting the mold piece to the opposing mold piece for molding the second section; and
radially separating the opposing mold piece from the mold piece to provide an axial flash line on the housing extending from one side of the circumferential flash-line.

Fabricating part of the housing in this way provides greater flexibility in terms of the outer profile of the housing in places where there are to be no O-rings and thus an axial flash-line is not problematic.

According to a further aspect of the present invention there is provided a housing for a control valve of a control valve assembly made using the aforementioned method.

According to a further aspect of the present invention there is provided a Central Tire Inflation System (CTIS) comprising a vehicle wheel assembly, the vehicle wheel assembly comprising a wheel hub and a control valve assembly removably mounted therein, wherein the control valve assembly is the aforementioned control valve assembly.

According to a further aspect of the present invention there is provided a vehicle comprising the aforementioned CTIS.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is an exploded perspective view of a vehicle wheel assembly;

FIG. 2 is a sectional view of the wheel hub with a control valve assembly shown in withdrawn position relative to the wheel hub;

FIG. 3 is a cross sectional view of the wheel hub with the control valve assembly installed;

FIGS. 4A-D show schematic representations of a latching valve in the control valve assembly in different operating modes;

FIG. 5 shows a schematic air supply pressure against time diagram over a cycle of the control valve assembly shown in FIGS. 4A-D;

FIG. 6 is a schematic representation of a vehicle equipped with a central tire inflation system (CTIS) including the vehicle wheel assembly from FIG. 1;

FIG. 7A is a sectional view of another vehicle wheel assembly and a vehicle wheel hub to which the wheel assembly can be mounted;

FIG. 7B is a detailed view of the area in dotted outline in FIG. 7A; and

FIG. 8A is a sectional view of the vehicle wheel assembly of FIG. 7 showing the wheel assembly mounted on the vehicle wheel hub;

FIG. 8B is a detailed view of the area in dotted outline in FIG. 8A;

FIG. 9 is a perspective view of a control valve assembly according to an embodiment of the present invention;

FIG. 10 is a reverse perspective view of the control valve assembly from FIG. 9;

FIG. 11 is a sectioned perspective view of a vehicle wheel assembly including the control valve assembly from FIG. 9;

FIG. 12 is a front view of the control valve assembly of FIG. 9 in an unlocked orientation;

FIG. 13 is a similar view as FIG. 12 of the control valve assembly in a locked orientation;

FIG. 14 is a section view of a mounting formation of an inlet of the control valve from FIG. 9;

FIG. 15 is a similar view as FIG. 14 of an alternative mounting formation;

FIG. 16 is a perspective view of a body part of the control valve assembly from FIG. 9;

FIG. 17 is a reverse perspective view of the body part from FIG. 16;

FIG. 18 is a perspective view of a cap part of the control valve assembly from FIG. 9;

FIG. 19 is a reverse perspective view of the cap part from FIG. 18;

FIG. 20 is a section view of the body part from FIG. 16;

FIG. 21 is a section view of the cap part from FIG. 18; and

FIG. 22 is a perspective view of an annular filter cage from the control valve assembly from FIG. 9.

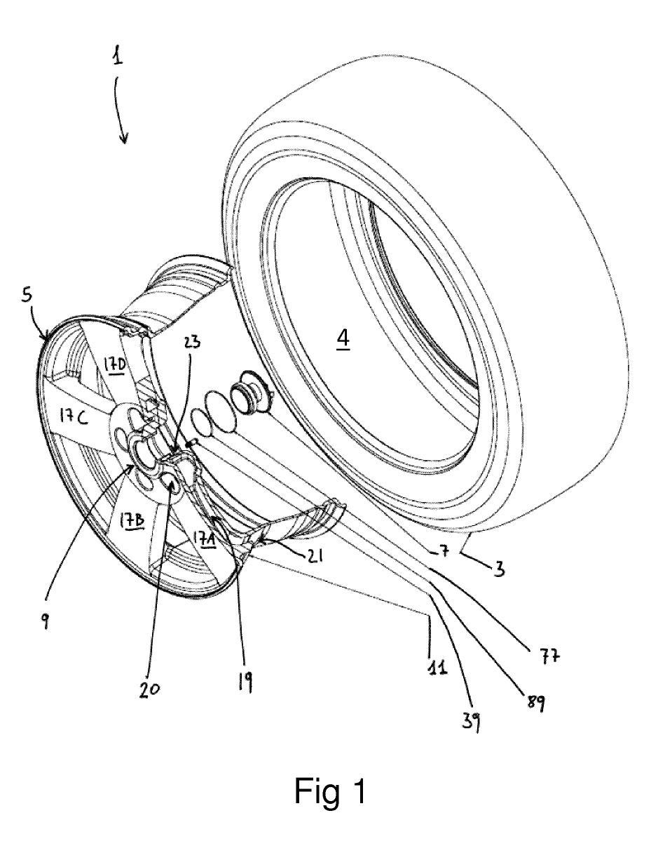

### DETAILED DESCRIPTION

A vehicle wheel assembly 1 in accordance with an embodiment of the present invention for application in a motor vehicle V will now be described with reference to the accompanying Figures. The vehicle wheel assembly 1 forms part of a central tire inflation system (CTIS) for controlling the pressure of a tire 3. The vehicle wheel assembly 1 can be implemented in a range of motor vehicles, including cars, off-road vehicles, sports utility vehicles (SUVs), trucks, buses and so on.

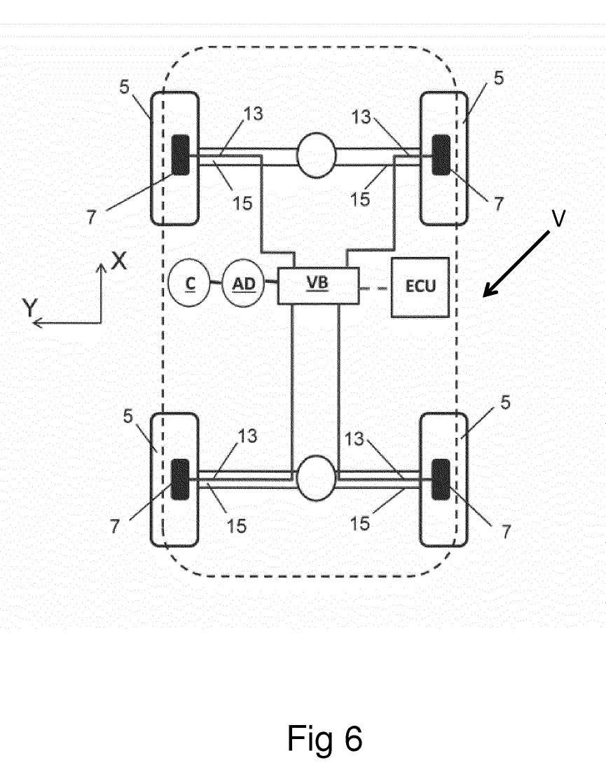

The vehicle wheel assembly 1 comprises a wheel 5 and a control valve assembly 7. The wheel 5 comprises a wheel hub 9, a wheel rim 11 and a plurality of spokes 17A-F (two of the spokes 17E and 17F have not been shown for clarity) which connect the wheel rim 11 to the wheel hub 9. The tire 3 locates on the wheel rim 11 in conventional manner. The control valve assembly 7 is removably disposed within the wheel hub 9 and is in fluid communication with a compressed air supply in the form of a compressor C and/or a reservoir (not shown) provided on the vehicle. In the present embodiment, fluid communication with the compressed air supply is established through a supply line 13 extending along a central axis of a drive shaft 15 (both shown schematically in FIG. 6). In use, the control valve assembly 7 is operable selectively to open and close the fluid connection between the supply line 13 and the tire 3.

In the example shown in the figures, the wheel 5 is made of a cast metallic alloy, such as aluminium or magnesium, and is of a type generally used in automotive vehicles. The wheel 5 has six spokes 17A-F, but can have less than or more than six spokes 17. A first spoke 17A is hollow and comprises a transfer line 19 extending radially outwardly from the wheel hub 9 to the rim 11. A first end of the transfer line 19 communicates with a radially outer opening 21 disposed on the rim 11 and through which the tire can be inflated/deflated; and a second end of the transfer line 19 communicates with a radially inner opening 23 disposed on the wheel hub 9. The radially outer opening 21 opens into an interior of the tire 3 such that a fluid pathway is established between the supply line 13 and the interior of the tire 3. The transfer line 19 could be machined in the first spoke 17A, but in the present embodiment it is formed during the casting process. The other spokes 17B-F can also be hollow to help balance the wheel assembly 1.

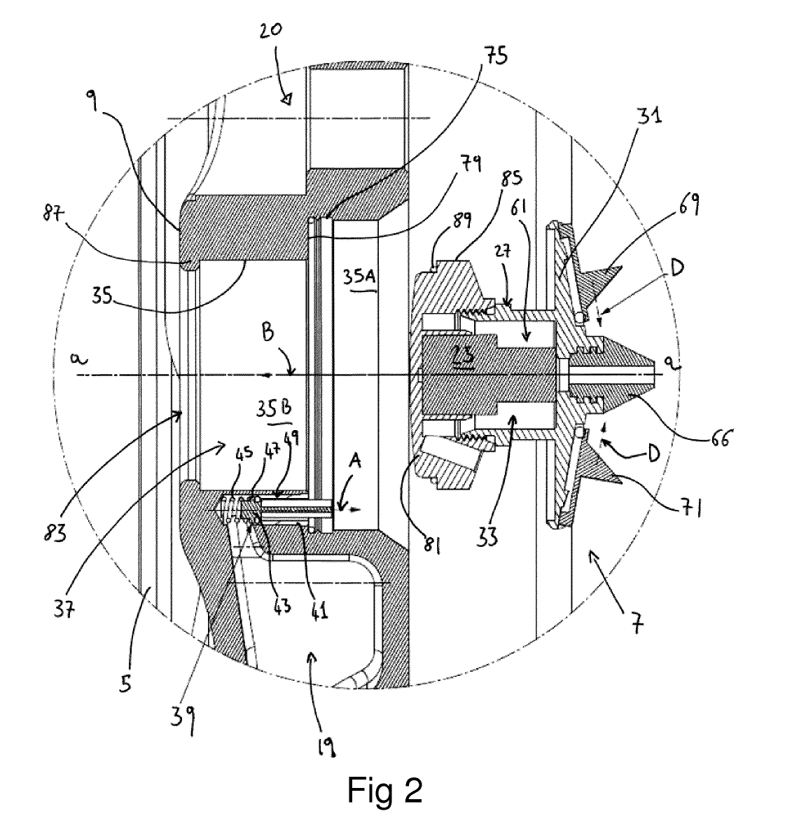

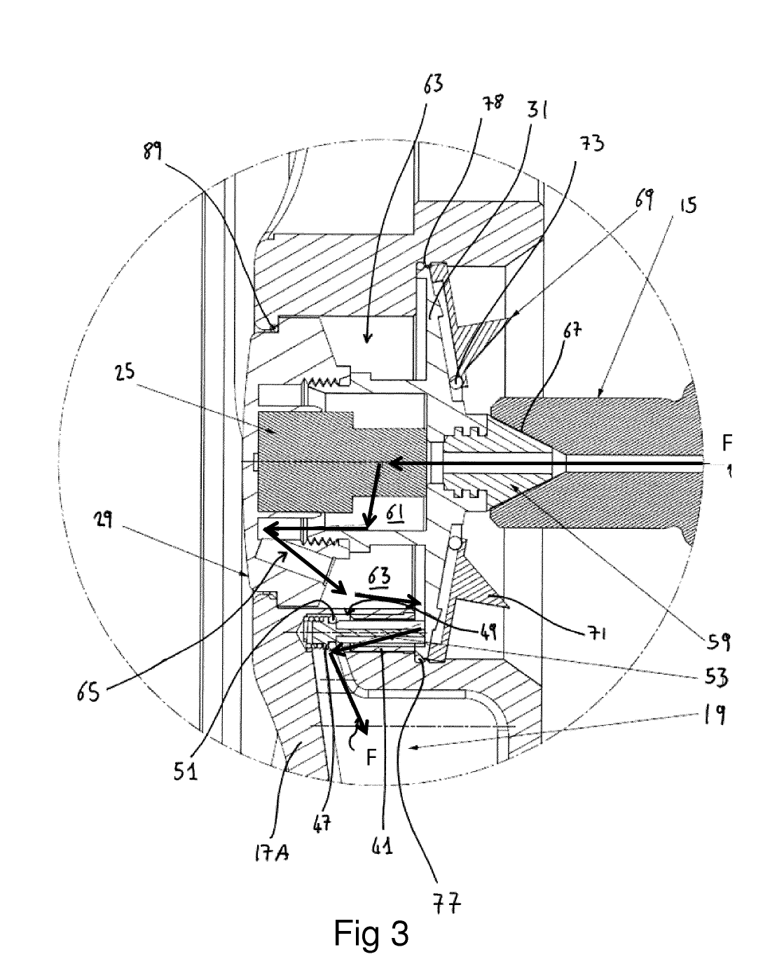

The control valve assembly 7 comprises a control valve 25 mounted in a housing 27. FIGS. 2 and 3 show in detail the housing 27, which housing 27 comprises a base member 29 and a closure member 31 which are threadedly connected to form a valve chamber 33 in which the control valve 25 is located, as shown in FIG. 2. The wheel hub 9 is adapted to receive the control valve assembly 7. Specifically, the wheel hub 9 comprises a stepped cylindrical sidewall 35, arranged co-axially with a rotational axis a-a of the wheel 5, which forms a central cavity 37 in which the control valve assembly 7 is removably mounted. As described herein, the wheel assembly 1 is assembled by locating the control valve assembly 7 in the central cavity 37. The wheel assembly 1 can then be mounted to the vehicle V in conventional manner by means of threaded studs and nuts or wheel bolts (not shown) fixedly mounted to a vehicle hub (not shown). The bolts extend through bores 20 formed in the wheel hub 9 and the wheel assembly 1 is secured by e.g. wheel nuts, as appropriate. In use, the control valve assembly 7 is fixedly mounted in position between the wheel hub 9 and the vehicle hub.

A wheel valve 39 is provided for sealingly closing the transfer line 19 in the first spoke 17A when the control valve assembly 7 is removed from the wheel hub 9. In the present embodiment, the wheel valve 39 is disposed at the radially inner opening 23 of the transfer line 19, but it could be disposed along the length of the transfer line 19 or at the radially outer opening 21. The wheel valve 39 comprises a fixed sleeve 41, a movable valve member 43, and a resilient biasing means in the form of a coil spring 45. The valve member 43 has a valve head 47 for cooperating with a valve seat 49 formed in the sleeve 41. The valve member 43 is movable between a closed position (shown in FIG. 2) in which the valve head 47 is seated in the valve seat 49; and an open position (shown in FIG. 3) in which the valve head 47 is spaced apart from the valve seat 49 (i.e. unseated). The valve member 43 is movable along an axis arranged substantially parallel to the central rotational axis a-a of the wheel 5 to minimize operational loads, for example centripetal forces as the wheel 5 rotates.

A first O-ring 51 is provided around the valve head 47 for forming a seal between the valve seat 49 and the valve member 43. When the valve member 43 is in its closed position, the wheel valve 39 is closed and the supply of air to the tire 3 and/or the exhausting of air from the tire 3 through the transfer line 19 formed in the first spoke 17A is inhibited. The spring 45 biases the valve member 43 towards its closed position, as illustrated by a first arrow A shown in FIG. 2.

Displacement means in the form of a pin 53 is coupled to the valve head 47 to cooperate with the control valve assembly 7 and displace the valve member 43 to its open position. Specifically, when the control valve assembly 7 is mounted in the wheel hub 9, the closure member 31 engages the pin 53 and displaces the valve member 43 to its open position, as shown in FIG. 3. When the valve member 43 is in its open position, the wheel valve 39 is open and the supply of air to the tire 3 and/or the exhausting of air from the tire 3 through the first spoke 17A is permitted. The direction of flow through the valve member 43 is dependent on the relative pressures in the supply line 13 and the tire 3. It will be appreciated that fluid communication between the control valve assembly 7 and an interior of the tire 3 is established when the control valve assembly 7 is mounted to the wheel hub 9.

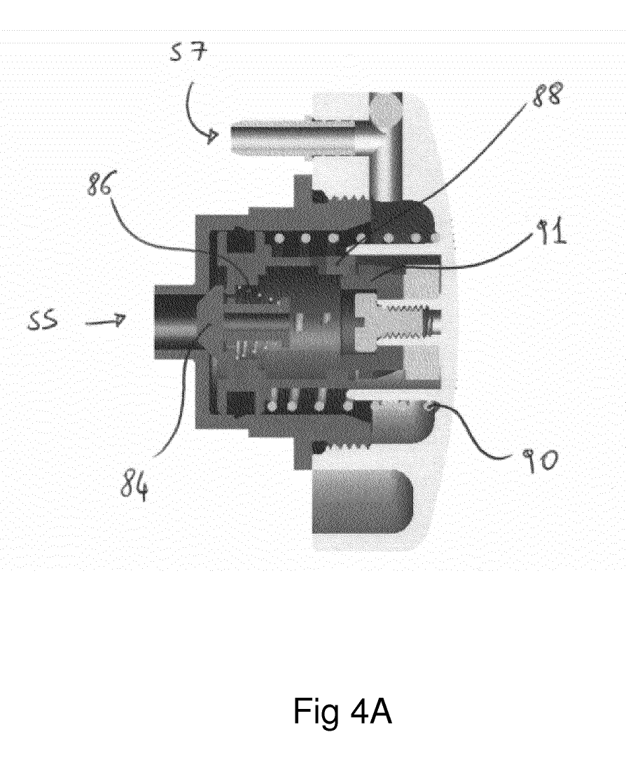

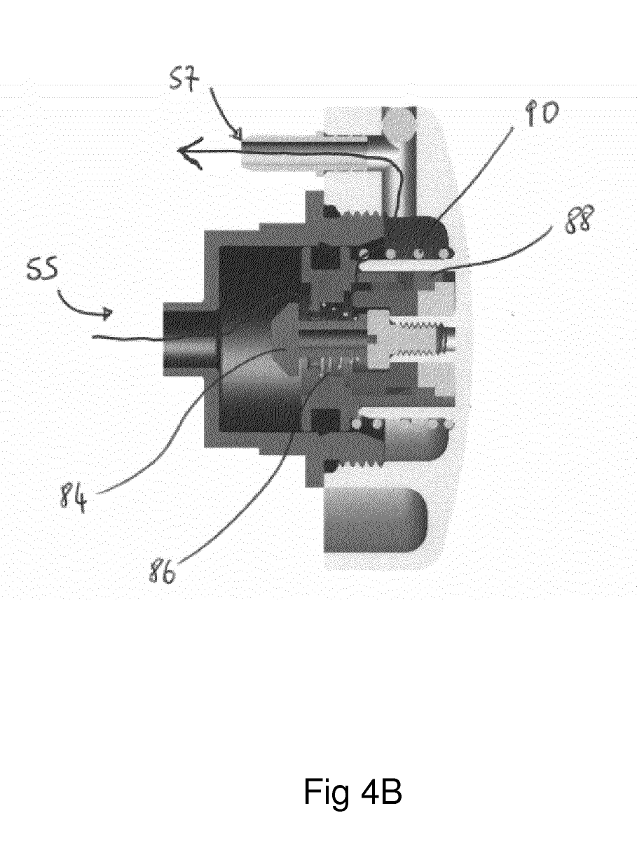

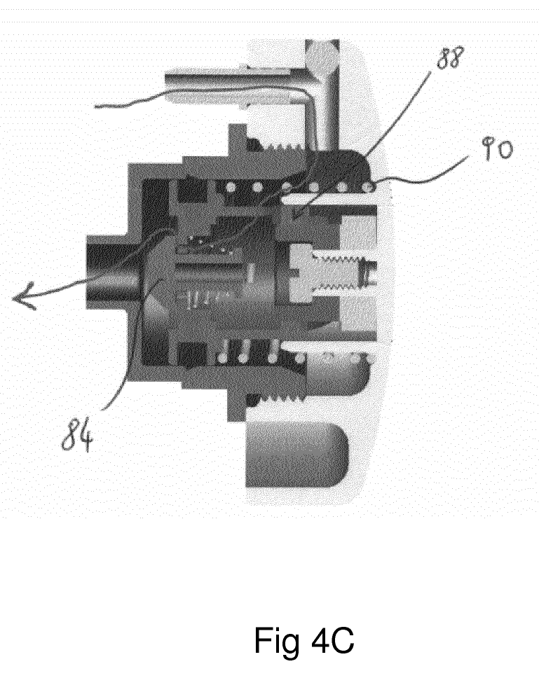

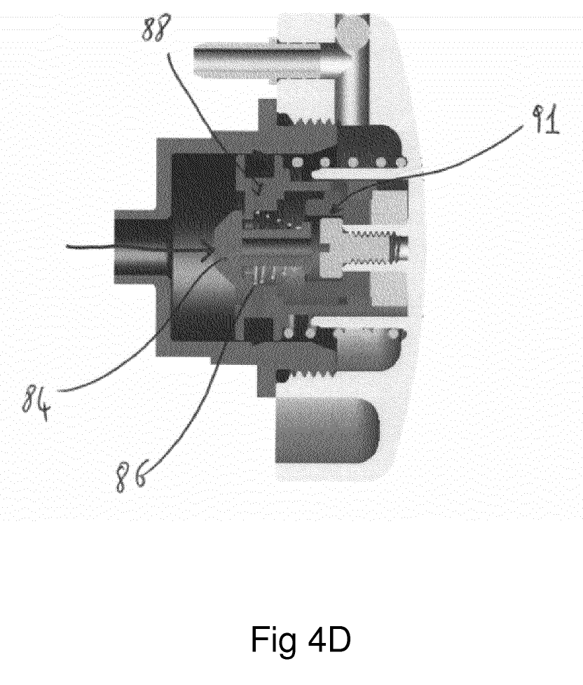

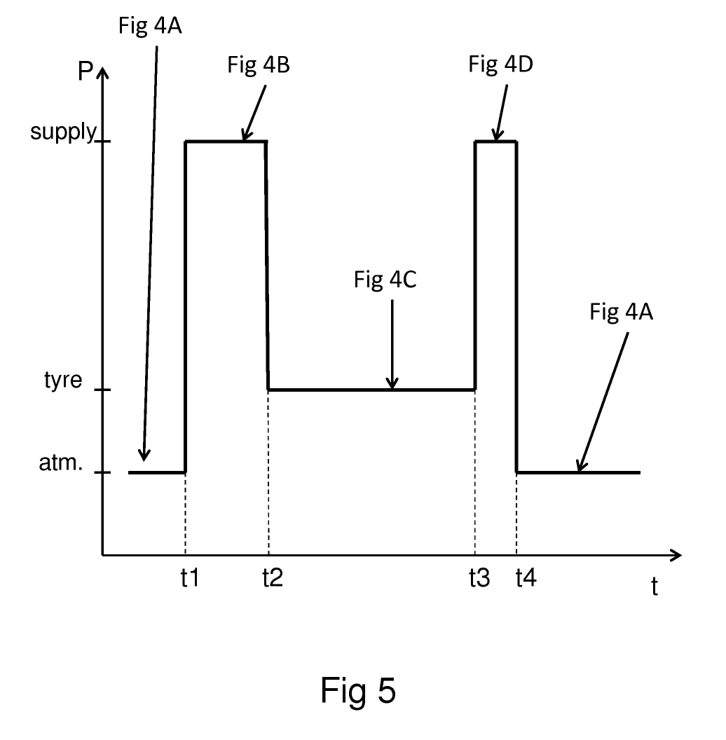

In the present embodiment, the control valve 25 is a pneumatic latching valve which can be selectively opened and closed in response to the application of control pressures. The control valve 25 has an axial inlet port 55 and a radial outlet port 57. A frusto-conical nozzle 59 is mounted to the inlet port 55 (shown in FIGS. 4A-D) for sealingly engaging the drive shaft 15 and establishing fluid connection with the supply line 13. The outlet port 57 is in fluid communication with the transfer line 19 formed in the first spoke 17A via the wheel valve 39. The control valve 25 can be selectively opened and closed to control the flow of compressed air between the inlet port 55 and the outlet port 57. The operation of the control valve 25 is described in more detail herein with reference to FIGS. 4A to 4D.

The control valve 25 is disposed centrally within the valve chamber 33 formed by the base member 29 and the closure member 31. A first annular chamber 61 is formed within the housing 27, extending circumferentially around the control valve 25 to maintain fluid communication with the outlet port 57 irrespective of the angular orientation of the control valve 25. A second annular chamber 63 is formed between the housing 27 and the wheel hub 9 to ensure that fluid communication with the transfer line 19 in the first spoke 17A is maintained irrespective of the angular orientation of the control valve assembly 7. The first and second annular chambers 61, 63 are arranged concentrically about the rotational axis a-a in the present embodiment. An offset bore 65 is formed in the base member 29 to establish fluid communication between the first and second annular chambers 61, 63. The wheel valve 39 opens into the second annular chamber 63, thereby establishing fluid communication between the supply line 13 and the first spoke 17A when the wheel valve 39 and the control valve 25 are open.

The nozzle 59 is formed from a resilient material, such as rubber, and has a frusto-conical outer surface 66 for sealingly engaging a cooperating inner surface 67 formed in the drive shaft 15. Said drive shaft inner surface could be cylindrical and could comprises a thread for engagement with a corresponding thread provided on a corresponding cylindrical outer surface of a stub axle fluid connector. This stub axle fluid connector can be substantially in the form of a bolt having a head configured to engage with the frusto-conical outer surface 66 of the nozzle 59. Said fluid connector can therefore threadedly engage with the cylindrical drive shaft inner surface at one end. At the other end, the fluid connector can receive the frusto-conical outer surface 66 of the nozzle 59 by means of a frusto-conical passageway formed in the head.

A pair of retaining clips 69, 71 is mounted to the closure member 31 for releasably fixing the control valve assembly 7 within the wheel hub 9. A spring 73 is provided to bias the clips 69, 71 radially outwardly to engage a first annular recess 75 formed in the cylindrical sidewall 35 of the hub 9. A second O-ring 77 is provided for forming a seal between the closure member 31 and the wheel hub 9. The second O-ring 77 locates in a second annular recess 78 formed in the cylindrical sidewall 35.

The control valve assembly 7 is removably mounted in the hub cavity 37 from an inside of the vehicle wheel assembly 1, as illustrated by a second arrow B in FIG. 2. A longitudinal axis of the control valve assembly 7 is arranged coaxially with the rotational axis a-a of the wheel 5. The cylindrical sidewall 35 comprises an inner cylindrical section 35A for accommodating the closure member 31 and an outer cylindrical section 35B for accommodating the base member 29. The inner and outer cylindrical sections 35A, 35B are arranged co-axially and offset relative to each other along said axis. The inner cylindrical section 35A has a larger diameter than the outer cylindrical section 35B. Further, the inner and outer cylindrical sections 35A, 35B share the same centerline, which corresponds, in this example, to the centerline of the wheel and the wheel hub, that is to say, the axis of rotation of the wheel. A radial surface 79 is formed in the cylindrical sidewall 35 to delimit the inner and outer cylindrical sections 35A, 35B.

A circular locating member 81 disposed at the end of the base member 29 locates in a circular aperture 83 formed in the hub 9. The locating member 81 extends through the hub 9 to the outer side of the wheel assembly 1. An annular flange 85, formed around the circular locating member 81, cooperates with an axial retaining means in the form an annular projection 87 formed in the wheel hub 9. A third O-ring 89 is mounted to the base member 29 to form a seal between the annular flange 85 and the annular projection 87.

The control valve assembly 7 is removably mounted within the hub cavity 37. When the control valve assembly 7 is located in the wheel hub 9, the locating member 81 is disposed within the circular aperture 83. When installed at a prescribed axial location within the wheel hub 9, the closure member 31 engages the pin 53 of the wheel valve 39, thereby displacing the valve member 43 to its open position. The annular flange 85 and third O-ring 89 abut the annular projection 87 and the closure member 31 and the second O-ring 77 abut the radial surface 79 formed in the wheel hub 9. The second and third O-rings 77, 89 form seals between the wheel hub 9 and the closure member 31 and the base member 29 respectively. The first and second annular chambers 61, 63 are thereby sealed when the valve control assembly 7 is located in the wheel hub 9. The clips 69, 71 locate in the first annular recess 75 formed in the wheel hub 9 to retain the control valve assembly 7 in position. The clips 69, 71 can be displaced radially inwardly to release the control valve assembly 7, as shown by arrows D in FIG. 2.

The fluid pathway through the control valve assembly 7 and the wheel 5 during tire inflation will now be described with reference to FIGS. 3 and 4. The fluid pathway is illustrated by a sequence of solid lines with arrows denoted generally by reference F. The compressed air is supplied through the supply line 13 and enters the control valve 25 through the inlet port 55. If the control valve 25 is closed, the flow of compressed air through the control valve 25 is inhibited. If the control valve 25 is open, the compressed air travels through the control valve 25 and exits through the outlet port 57 before entering the first and second annular chambers 61, 63.

The second annular chamber 63 is in fluid communication with the wheel valve 39. When the control valve assembly 7 is mounted in the wheel hub 9, the closure member engages the pin 53 and displaces the valve member 43 to its open position. The wheel valve 39 is thereby opened to establish fluid communication between the second annular chamber 63 and the cavity 4 of the tire 3 via the transfer line 19. The control valve 25 is operable to control the supply of compressed air between the supply line 13 and the tire 3.

To inflate the tire 3, the control valve 25 is opened by high pressure air supplied by the compressor C (or by an alternative compressed air reservoir) through the supply line 13. This step is represented by the raising pressure gradient at time t1 in FIG. 5. In particular, the control valve 25 is opened when the supply air pressure exceeds a predetermined threshold. When inflating, the supply air pressure is raised, the control valve 25 opens and air flows into the tire cavity 4 (interval between times t1 and t2 in FIG. 5). Once the air pressure inside the tire cavity 4 has reached the desired level (at time t2 in FIG. 5), the supply air pressure is momentarily dropped and then raised above the valve operation threshold briefly (i.e. between times t3 and t4 in FIG. 5, corresponding typically to a time interval of about 0.5 s) before returning to approximately ambient pressure (corresponding to time t4 in FIG. 5). The control valve 25 is thus closed and the tire cavity 4 is now sealed by the control valve 25.

Deflation requires the supply air pressure to be raised again, briefly, above the valve operation threshold to open the control valve 25 to allow air to leave the tire cavity 4. The control valve 25 then needs to be operated again, briefly, in the same manner, i.e. by applying a supply air pressure above the valve operation threshold to close the control valve 25 to seal the tire cavity 4. The pressure of air in the tire cavity 4 is measured by a tire pressure monitoring system (TPMS) sensor (not shown) mounted on the wheel rim 11.

As depicted in FIG. 6, the operation of compressor C can be controlled by valve block VB comprising solenoid valves (not shown) actuated by an electronic control unit (ECU). In the present embodiment, the ECU is configured to operate the valve block VB to control the opening and closing of the control valve 25 as described herein. An air dryer AD is provided between the compressor C and the valve block VB. The pressure in each wheel can be controlled independently, or the pressures of the two front wheels can be can be controlled together or the pressures of the four wheels (front and back) can be controlled together.

The operation of the control valve 25 will now be described in more detail with reference to the schematic representations shown in FIGS. 4A to 4D. The control valve 25 comprises valve means in the form of a poppet valve 84, a poppet spring 86 for loading the poppet valve 84, a piston assembly 88, a piston spring 90 loading the piston assembly 88 and a latch 91. The poppet valve 84 and the piston assembly 88 are arranged co-axially with the rotational axis a-a of the wheel 5 to reduce operational loads, for example centripetal forces caused by rotation of the wheel 5. The latch 91 comprises a rotary latching mechanism which sequentially rotates through first, second, third and fourth position to define different operating modes. The latch 91 is controlled by the air pressure at the inlet port 55. Thus, the supply line 13 functions as a control line for the control valve 25. The operating modes will now be described in sequence.

During a normal running mode, no compressed air is supplied to the supply line 13 and the pressure in the supply line 13 is substantially equal to, or slightly above, atmospheric pressure. The poppet valve 84 is displaced to its closed position (as shown in FIG. 4A) under the action of the poppet spring 86 and the fluid pressure from the tire side. The control valve 25 is closed, thereby maintaining the pressure of the tire 3. The latching mechanism is in a first position when the control valve 25 is operating in the normal running mode.

To operate in an inflate mode, full pressure is supplied to the inlet port 55 of the control valve 25. As shown in FIG. 4B, the piston assembly 88 is displaced against the action of the piston spring 90 (to the right in the illustrated arrangement). The displacement of the piston assembly 88 causes the poppet valve 84 to lift in relation to the piston assembly 88 allowing compressed air to flow through the control valve 25. The tire 3 can be inflated to a required pressure. The latch 91 rotates to a second position during the inflate mode. As shown in FIG. 5, after the tire pressure has been adjusted as desired, the poppet valve 84 must be operated again, by supplying full pressure, in order to close the control valve 25, so that the tire cavity 4 remains sealed.

To operate in a deflate/pressure check mode, the poppet valve 84 must be operated again in the same manner, i.e. by supplying full pressure, and then the pressure supplied to the inlet port 55 is reduced to tire pressure or below. The piston assembly 88 moves under the action of the piston spring 90 (to the left in the illustrated arrangement), but is stopped by the latch 91 and held in an intermediate position, as shown in FIG. 4C. The poppet valve 83 can readily be opened by tire pressure so the pressure in the tire 3 can be reduced, if desired. If the supply line 13 is closed, the tire pressure can be measured. The latch 91 rotates to its third position when the deflate/pressure check mode is engaged.

To reset the control valve 25, again full pressure is applied to the inlet port 55 and the piston assembly 88 is displaced against the action of the piston spring 90 (to the right in the illustrated arrangement). However, the piston assembly 88 is stopped by the latch 91 and the poppet valve 84 is prevented from lifting from the piston assembly 88. The control valve 25 thereby remains closed throughout the reset operation and the tire pressure does not change. Finally, the latch 91 rotates to its fourth position in preparation for returning to the normal run mode.

As described herein, the control valve assembly 7 is removably mounted in the hub cavity 37. When the vehicle wheel assembly 1 is installed on the vehicle, the control valve assembly 7 is fixed in position between the wheel hub 9 and the vehicle hub so that it rotates with the wheel when the vehicle in in motion. The control valve assembly 7 can only be removed once the vehicle wheel assembly 1 has been removed. In particular, the vehicle wheel assembly 1 is removed from the vehicle hub by undoing the wheel nuts (or bolts) and lifting the entire wheel assembly 1 off of the mounting bolts. The retaining clips 69, 71 are then squeezed together and released from the first annular recess 75 to enable the control valve assembly 7 to be removed from the wheel hub 9. The control valve assembly 7 is removed axially, along the rotational axis a-a towards the inner side of the vehicle wheel assembly 1. When the control valve assembly 7 is removed, the closure member 31 is lifted clear of the pin 53 and the valve member 43 is displaced to its closed position by the fluid pressure in the tire 3 and the bias applied by the spring 45. The wheel valve 39 is thereby closed and the transfer line 19 is sealed, inhibiting the venting of air from the tire 3 to atmosphere. The removal of the control valve assembly 7 facilitates routine maintenance and servicing, for example to replace the tire 3 and/or balance the vehicle wheel assembly 1. The tire 3 and the wheel 5 can be serviced according to conventional procedures after the control valve assembly 7 has been removed. Should the wheel 5 be damaged to an extent that the wheel 5 is no longer roadworthy, the wheel 5 can be replaced by any suitable conventional wheel. Vice versa, it will be understood that the wheel 5 can be mounted on any suitable vehicle not equipped with a CTIS, e.g. to replace a conventional wheel.

To assemble the vehicle wheel assembly 1, the control valve assembly 7 is located in the hub cavity 37 and displaced along the axis a-a until the retaining clips 69, 71 locate in the first annular recess 75. The closure member 31 engages the pin 53 and displaces the valve member 43 to its open position. The wheel valve 39 is thereby opened and fluid communication established between the tire 3 and the control valve 25. The second annular chamber 63 maintains fluid communication between the control valve 25 and the transfer line 19 irrespective of the angular orientation of the control valve assembly 7. The retaining clips 69, 71 help to prevent the control valve assembly 7 being displaced out of the hub cavity 37 due to the pressure increase when the wheel valve 39 is opened. The vehicle wheel assembly 1 can then be mounted to the vehicle hub. The nozzle 59 locates in the end of the drive shaft 15 and a seal is formed between the respective surfaces 66, 67. The vehicle wheel assembly 1 is secured in position by the wheel nuts (or bolts) in conventional manner.

Once installed, the control valve assembly 7 is operable to control the supply of compressed air from the compressor to the tire 3. Specifically, the control valve 25 is operable selectively to open and close the fluid pathway between the supply line 13 and the transfer line 19. In the present embodiment, the control valve 25 is actuated in response to changes in the pressure in the supply line 13. The control valve 25 comprises a latching mechanism which cycles through a sequence of operating modes to provide a normal operating mode; an inflate mode; a deflate/pressure check mode; and a reset mode. The ECU controls operation of the compressor C and/or the associated valve block VB to control the supply of compressed air to the supply line 13 to control operation of the control valve 25. It will be appreciated that the operating sequence of the control valve 25 could be changed with corresponding changes to the control strategy implemented by the ECU.

Although tire inflation operations have mostly been referred to in the above passages, it will be clear that the present invention can also be used in tire deflation modes, insofar as an appropriate control valve is used, for example one according to FIGS. 4A to 4D. During tire deflation, the compressed air from the tire 3 can be exhausted back through the supply line 13 to a reservoir or to atmosphere. The venting of air from the tire 3 can be controlled by the valve block VB. Alternatively, the control valve 25 could be configured to vent air from the tire 3 directly to atmosphere, for example through an outlet port, or the control valve 25 could be configured to return air from the tire cavity 4 to a bi-directional flow compressor for forced evacuation from the tire cavity 4 so as to greatly reduce tire deflation cycle time.

A service valve such as a Schrader valve can be provided on the wheel to provide a conventional means of checking and adjusting tire pressure. The Schrader valve could be provided on the wheel rim 11 or in the hub, for example in communication with a second conduit. The Schrader valve could be positioned diametrically opposite the wheel valve 39 to help balance the wheel assembly 1.

Embodiments of the present invention can be used to take pressurized air made available at the vehicle axle to the tire 3. In the above passages, we have described: a specifically designed wheel 5; a specifically designed control valve assembly 7, and a vehicle wheel assembly 1 resulting from the assembly of the wheel 5 and the control valve assembly 7.

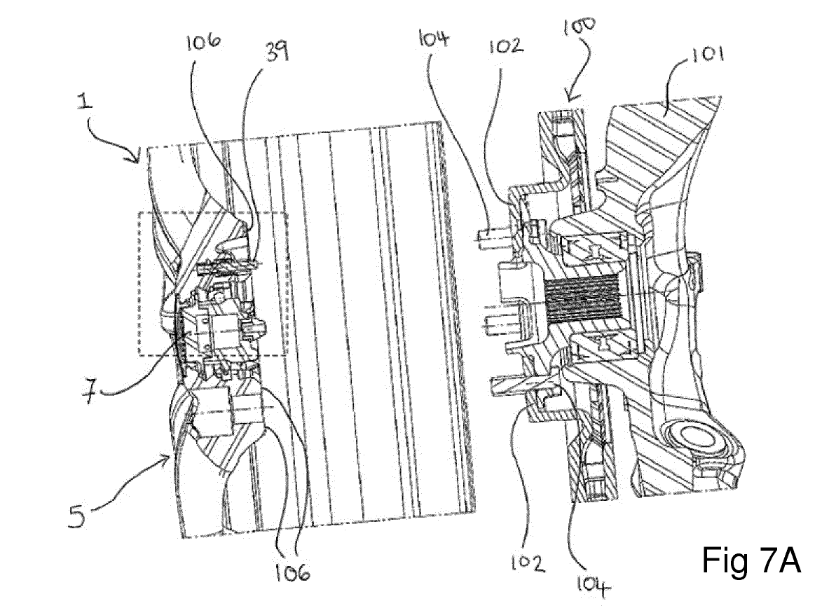

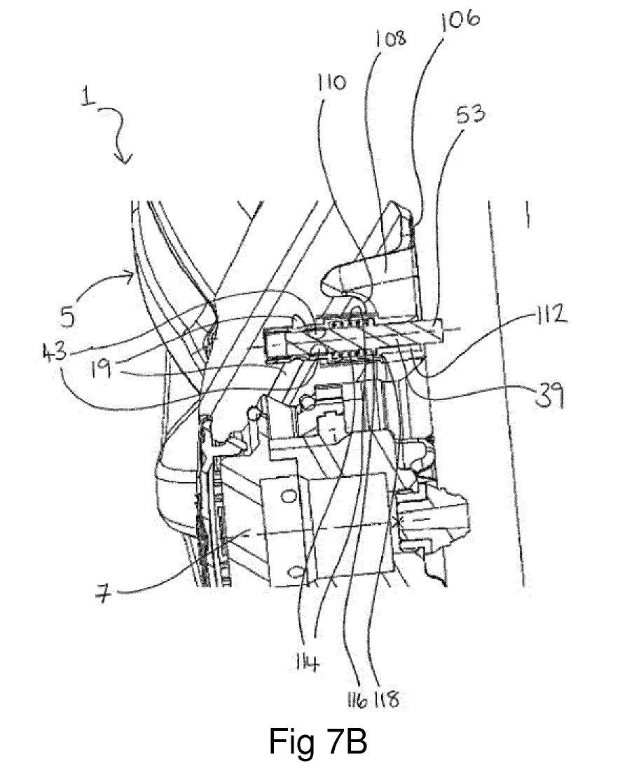

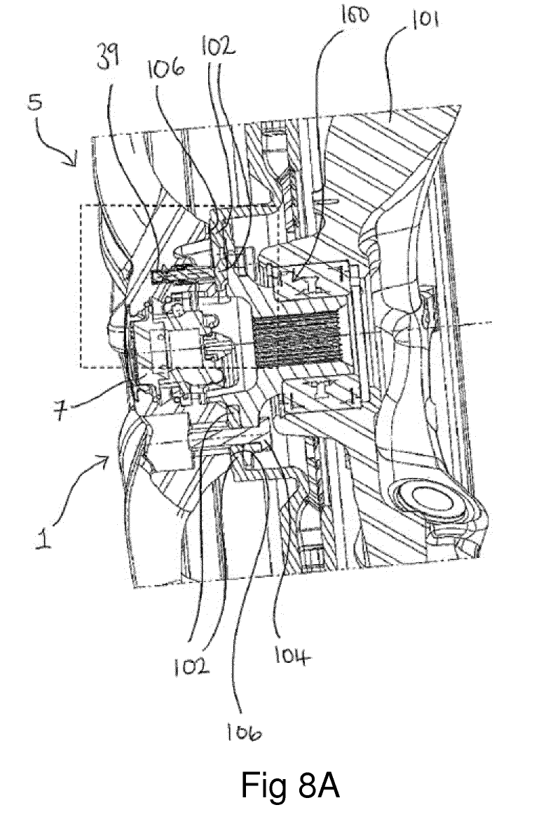

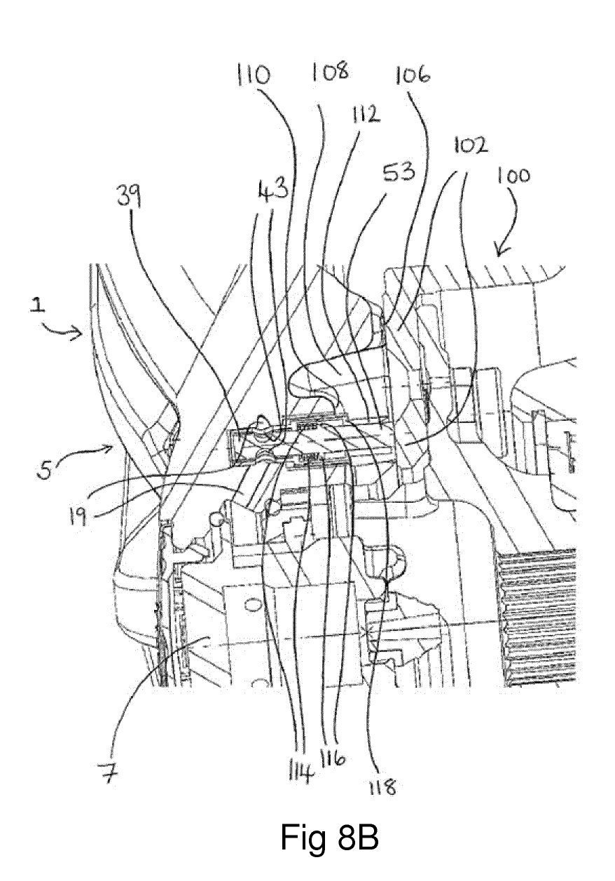

In the embodiment described previously, the in-wheel valve 39 has been provided to stop the tire from deflating once the control valve assembly 7 is removed from the wheel. The in-wheel valve 39 is actuated (held in the open state) when the control valve assembly 7 is fitted to the center of the wheel 5 by means of a mechanical action of a valve pin 53 being pressed down as the control valve assembly 7 is mounted to the wheel 5, thus opening the in-wheel valve 39. The in-wheel valve 39 thereby functions as an isolation valve which closes the transfer line 19 when the wheel 5 and the control valve assembly 7 are removed from the wheel hub, for example for tire fitting/balancing purposes. In a modified arrangement of the wheel assembly 1, this functionality is preserved but the location of the in-wheel valve 39 is changed. In particular, the in-wheel valve 39 is arranged such that the valve pin 53, which controls operation of the valve member 43, cooperates with the vehicle wheel hub rather than the control valve assembly 7. This modified arrangement, as illustrated in FIGS. 7 and 8, will now be described in more detail.

The vehicle wheel hub assembly 100, in use, is held in a knuckle 101. The vehicle wheel hub assembly 100 conventionally comprises a hub mounting flange 102 having a plurality of threaded studs 104 for mounting the wheel assembly 1. In the embodiment illustrated in FIGS. 7 and 8, the hub assembly 100 includes a brake disc (not shown), and the hub mounting flange 102 is provided by the brake disc. However, in other embodiments, the vehicle wheel hub may comprise other components which provide the hub mounting flange. In the modified arrangement of FIGS. 7 and 8, the in-wheel valve 39 is positioned radially outwardly of the control valve assembly 7 such that the valve pin 53 engages the hub mounting flange 102. The wheel has a wheel mating surface 106 which abuts the hub mounting flange 102 when the wheel assembly 1 is mounted to the vehicle hub 100. There are recesses 108 in the surface of the wheel 5 which is opposite the hub mounting flange 102 when the wheel assembly 1 is mounted to the vehicle hub 100. The recesses 108 have recessed surfaces 110 which do not abut the hub mounting flange 102. The in-wheel valve 39 comprises a valve housing 112 which surrounds the valve pin 53. The valve housing 112 and the valve pin 53 extend through an aperture formed in a recessed surface 110. The housing 112 extends from the recessed surface 110 a distance short of the wheel mating surface 106, such that, when the wheel assembly 1 is mounted to the vehicle hub 100, the housing 112 does not abut the wheel mating surface 106. The valve pin 53 extends further than the housing 112 such that it protrudes out of the recess 108, beyond the plane of the wheel mating surface 106, when the wheel assembly 1 is not mounted to the vehicle hub 100. The valve pin 53 can be arranged to extend perpendicular to the wheel mating surface 106. In an alternative embodiment, the valve pin 53 may extend through an aperture formed in a wheel mating surface 106 of the wheel 5. In such an arrangement, a valve housing 112 may not be needed. An O-ring or other sealing member can be provided around the valve pin 53 to prevent air loss.

In use, when the wheel assembly 1 is mounted to the vehicle wheel hub assembly 100, the hub mounting flange 102 engages the valve pin 53 and displaces the valve member 43 to its open position. The in-wheel valve 39 is thereby opened when the wheel assembly 1 is mounted to the vehicle hub. Conversely, when the wheel assembly 1 is removed from the vehicle wheel hub 100, the hub mounting flange 102 disengages from the valve pin 53 and the valve member 43 is returned to its closed position under the action of a coil spring 114. The in-wheel valve 39 is thereby closed when the wheel assembly 1 is removed from the vehicle wheel hub 100. The position of the valve pin 53 when disengaged from the hub mounting flange 102 is controlled by a pin protrusion 116 which abuts a stop 118 formed in the housing 112. In this modified arrangement, the removal or fitting of the control valve assembly 7 can be performed without actuating the in-wheel valve 39. The operation of the wheel assembly 1 is unchanged from that of the embodiment described previously.

It will be appreciated that the in-wheel valve 39 can be actuated by various means, including the fitting of the control valve assembly 7, and/or the fitting of the wheel assembly 1 to the vehicle.

Various alternative embodiments of the control valve assembly 7 and vehicle wheel assembly 1 exist. Those features in common with the aforementioned embodiment are not necessarily expressly described and those which are described are labelled 500 greater.

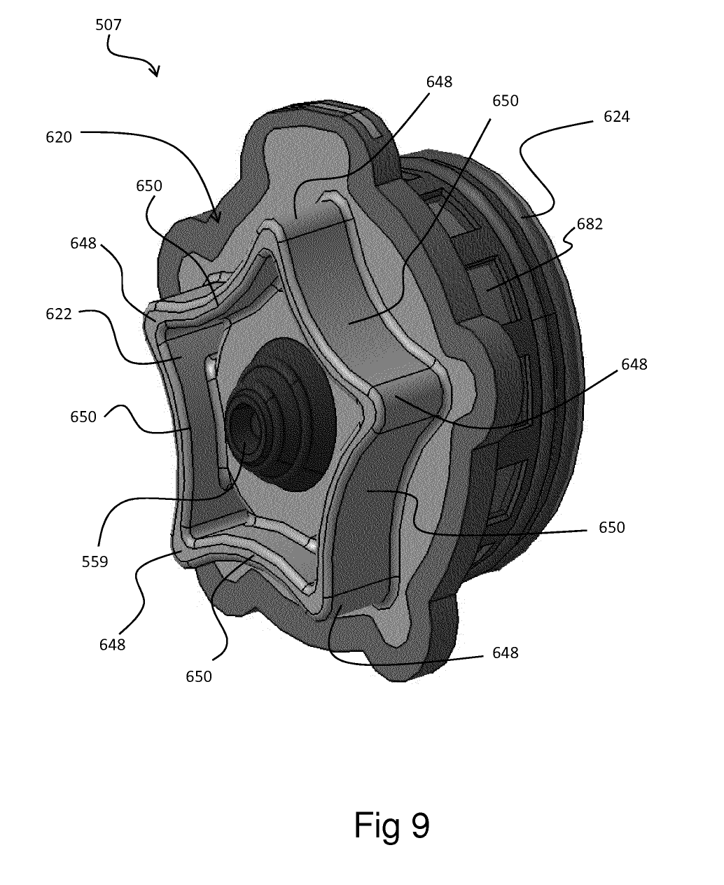

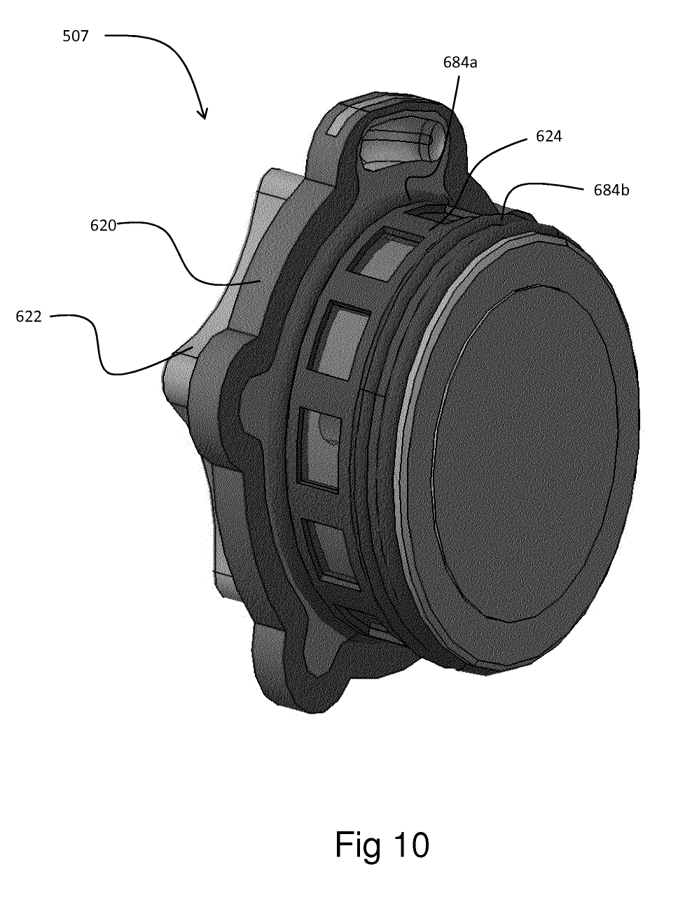

With reference to FIG. 9 and FIG. 10, according to a further embodiment, the control valve 507 includes a peripheral flange 620, a grip 622, a nozzle 559, and a cage 624. No control valve 25 is shown, like in the previous embodiment (FIGS. 2 and 3 for instance) for ease of reference to the modified features of the control valve 507 in this embodiment. However, a control valve would be provided for operation as described above.

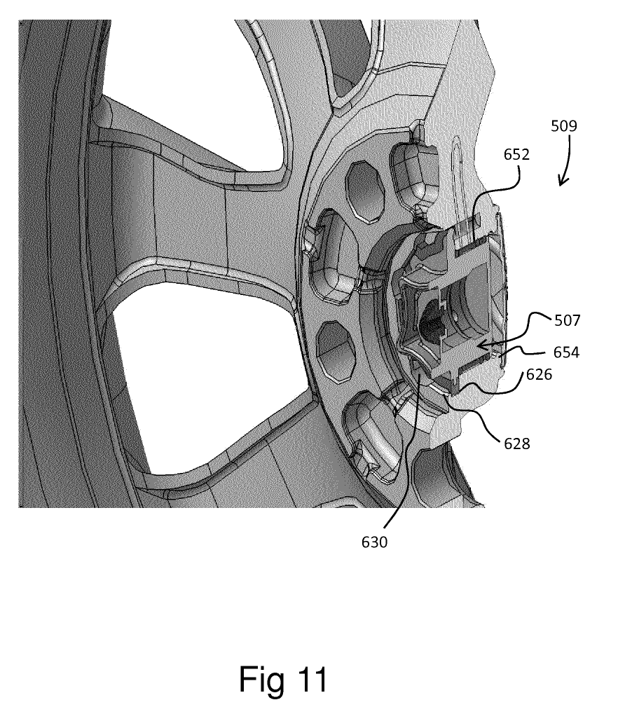

With reference to FIG. 11, the wheel hub 509 is shown having the control valve assembly 507 installed therein. The wheel hub 509 comprises a track 626 including circumferentially spaced overhangs 628 each separated by a gap 630.

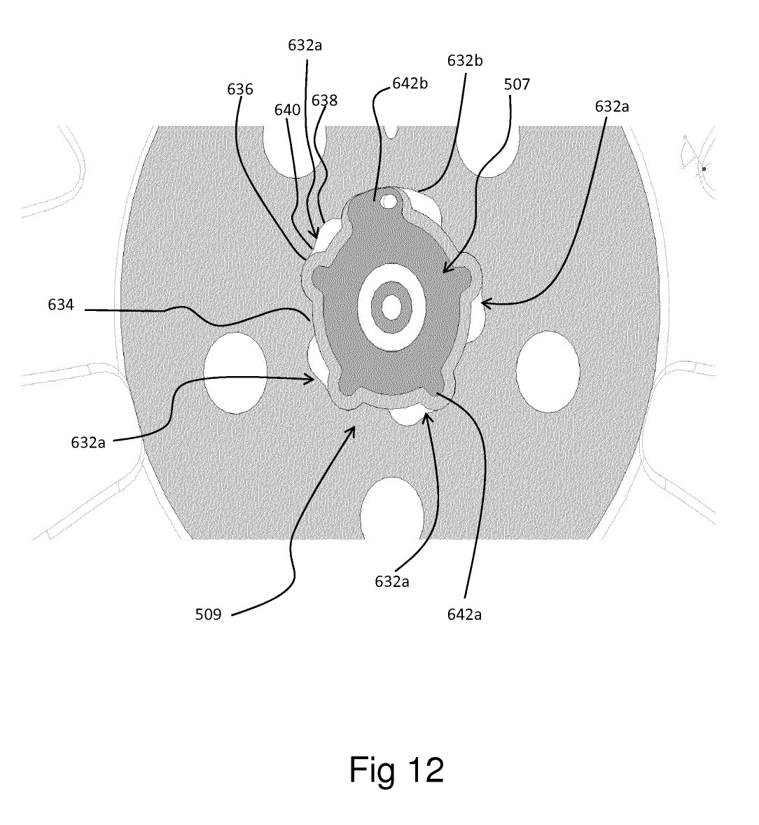

With reference to FIG. 12, the track 626 includes five channels each separated by a shoulder 634. Four of the five channels 632a are bilobal, each having two lobes 636, 638 separated by a rib 640. The rib 640 extends generally inwardly, that is to say towards the axis of rotation, relative to the two lobes 636, 638. Each gap 630 is aligned with one of the lobes 636 whereas the overhangs 628 are aligned with the other lobes 638. The other, unique, channel 632b is broader than the others and does not include the rib 640 but rather includes a single lobe. Similarly, the gap covering part of the unique single lobed channel 632b is broader than the other gaps 630.

With further reference to FIGS. 9 and 10, the peripheral flange is generally circular in shape having five bosses 642 (FIG. 12) extending radially outwards. Four of the bosses 642a are identical. One boss 642b is shaped differently to the other bosses 642a. This unique boss 642b is broader than the others. The peripheral flange 620 is made from a compliant material, such as a suitable elastomer. The gaps 630 (shown in FIG. 11) of the wheel hub 509 are orientated and positioned to correspond with the bosses 642 when the valve assembly 507 is placed in an unlocked condition as will be described further. Specifically, there are four narrow gaps 630a and one broad gap 630b. In this way, in a first orientation, when the bosses 642 are aligned with the gaps 630, the control valve assembly 507 can pass axially past the overhang 628 to an installed location within the hub 509. The unique boss 642b can only fit through one gap 630b, namely, the relatively broad gap 630b, such that the control valve assembly is limited to fitting to the hub in a single orientation. In this way, the broad boss 642b and the broad gap 630b form an alignment element.

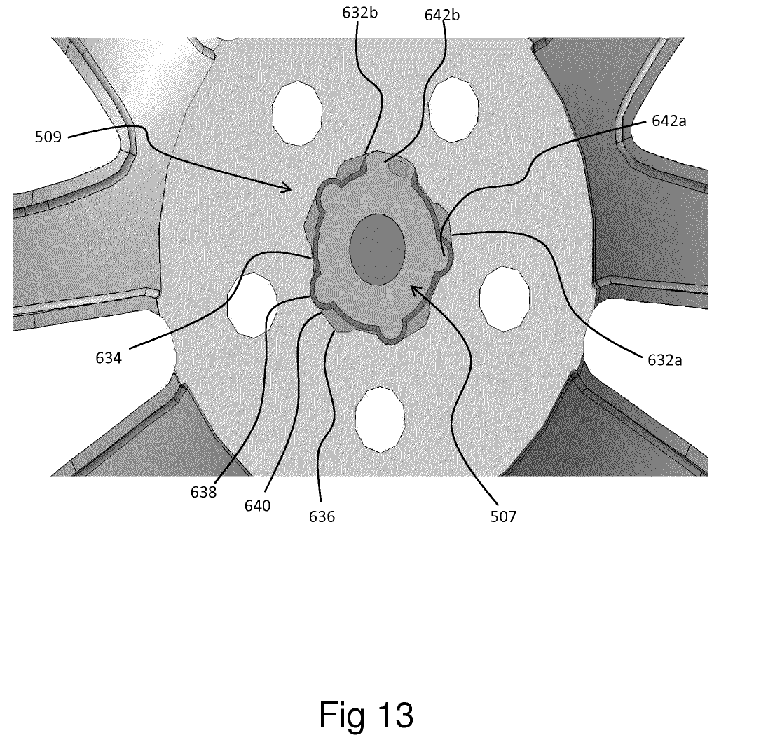

In the installed location, the control valve assembly 507 is rotatable from the first orientation corresponding to an unlocked condition, to a second orientation corresponding to a locked condition, by clockwise movement of the control valve assembly 507. FIG. 12 shows the control valve assembly in the unlocked condition. FIG. 13 shows the control valve assembly in the locked condition.

In the first (unlocked) orientation, each boss 642 is aligned one of the lobes 636. In the second (locked) orientation, each boss 642 is aligned with the other lobes 638. When moving between the unlocked and locked orientations, the bosses 642 deflect inwardly by the ribs 640 then rebound to their neutral undeflected positions when aligned with the second lobes 638 in the locked orientation. When in the locked orientation, the control valve assembly 507 is prevented from separating axially from the wheel hub 509 since the bosses 642 are aligned with the overhangs 628. The rib 640, the overhang 628, and the shoulder 634 thus cooperate to secure the bosses 642 in the locked orientation.

In this way, the control valve assembly 507 includes features arranged to provide a locking mechanism for engagement with corresponding features in the wheel, in the form of a twist lock, which may be selectively engaged to lock or unlock the control valve assembly 507 within the wheel hub 509.

When the control valve assembly 507 is mounted within the wheel hub 509, the peripheral flange 620 forms a compliant ring providing a damping element to damp vibrations which may otherwise adversely affect the valve assembly 507.

With further reference to FIGS. 9 and 10, the control valve assembly 507 also includes a gripping formation in the form of a grip 622, arranged to provide a suitable surface for grasping by hand during installation into- or removal from the wheel. The grip 644 is in the form of a wall extending axially from the control valve in a direction away from the wheel hub 509 (FIG. 11), in-use. The wall is continuous and includes five peaks 648 and troughs 650. Each peak 648 is aligned with a boss 642. There are five troughs 650 so as to allow a user to grip the control valve assembly 507 using each finger and thumb of their hand. In this way, the control valve assembly 507 can be fitted to the wheel hub 509 by hand so that no additional tooling is required to fit or remove the valve assembly 507 to/from the wheel hub 509. It will be appreciated that this gripping feature may be further provided with surface formations such as knurling etc. to further optimize the surface of the wall for grasping by hand.

With further reference to FIG. 11, the wheel hub 509 comprises a mounting structure 652 in the form of an annular wall for removably receiving the control valve assembly 507 within the wheel hub 509. In addition, the wheel hub 509 includes a sacrificial lip 654 extending radially inwardly relatively to the mounting structure 652. The sacrificial lip 654 is used to support the wheel hub 509 when removed from the vehicle during maintenance operations. In these off-vehicle operations, the wheel may be placed on a balancing shaft or other such servicing tool commonly used for wheel and/or tire maintenance or repair. The sacrificial lip 654 can be damaged and wear during such operations throughout the life of the vehicle without compromising the usability of the wheel.

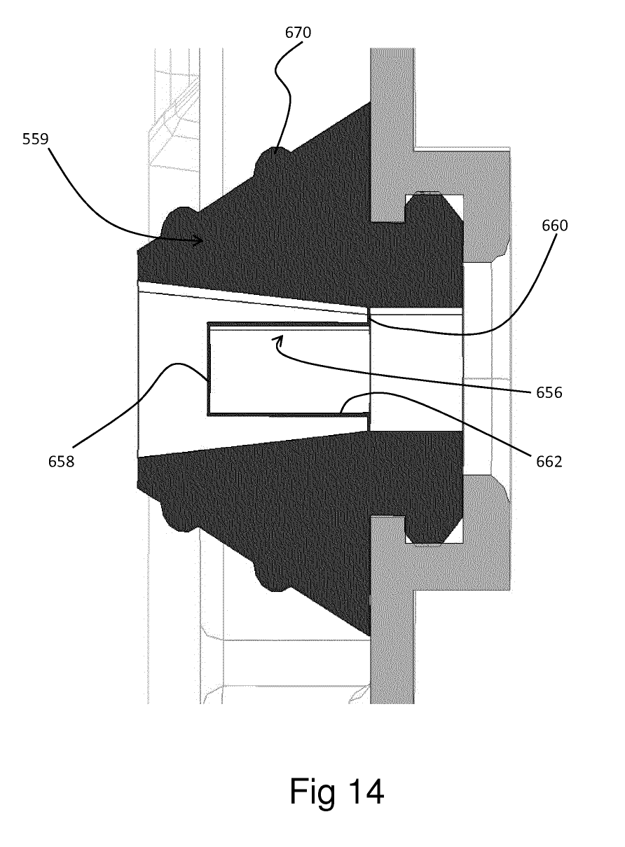

With reference to FIG. 14, the nozzle 559 of this embodiment is a mounting formation for mounting the control valve assembly 507 to the axle stub (not shown in FIG. 14). The nozzle 559 includes a supply line filter 656 for filtering air flowing from the supply line, in the stub axle, to the control valve assembly 507. Though in principle, the supply line filter 656 can also filter air flow in the reverse direction. Various different structural configurations of filter are possible, two of which are described below.

Still with reference to FIG. 14, a first supply line filter configuration is in the form of a ‘top-hat’ having a cap or disc 658 separated axially from a rim or annulus 660 by a cylinder 662. The disc 658 is upstream of the annulus 660 when filtering air from the supply line entering the control valve assembly. The ‘top-hat’ shape limits clogging of the supply line filter 656 to the region adjacent to annulus 660 allowing particles to collect at a downstream end of the filter, so leaving the upstream region adjacent the disc 658 relatively clear of debris. In this way, the disc 658, and the upstream end of the cylinder 662 remain free for filtering air flow.

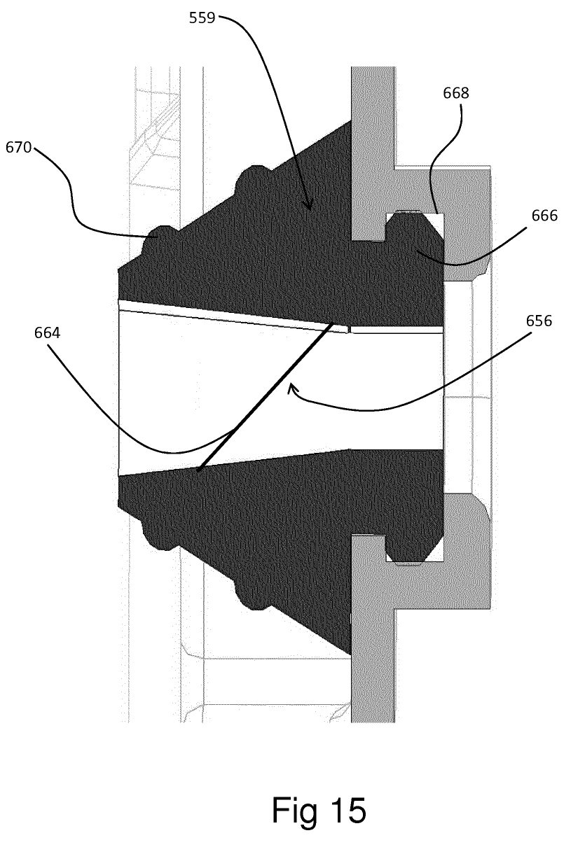

With reference to FIG. 15, an alternative supply line filter 656 configuration is shown, in the form of a disc 664 mounted diagonally within the nozzle aperture to be inclined relative to air impinging on the supply line filter 656. The supply line filter 656 thus collects particulate matter at a downstream end leaving the upstream end relatively free for filtering purposes.

Regardless as to the configuration of the supply line filter 656 implemented in the nozzle 559, the nozzle 559 and the supply line filter 656 are integrally formed as a substantially monolithic structure. The nozzle 559 includes an annular flange 666 mounted within a groove 668 of the control valve. Since the nozzle 559 is made from a resilient material, the nozzle 559 can be removably and replaceably mounted to the control valve by deflection of the flange 666 passing through to the groove 668.

The nozzle 559 also includes finger grips 670 in the form of annular formations. The finger grips allow for easy removal by a user's fingers. Accordingly, there is no need for additional tooling to install and remove the nozzle 559 when replacement is required.

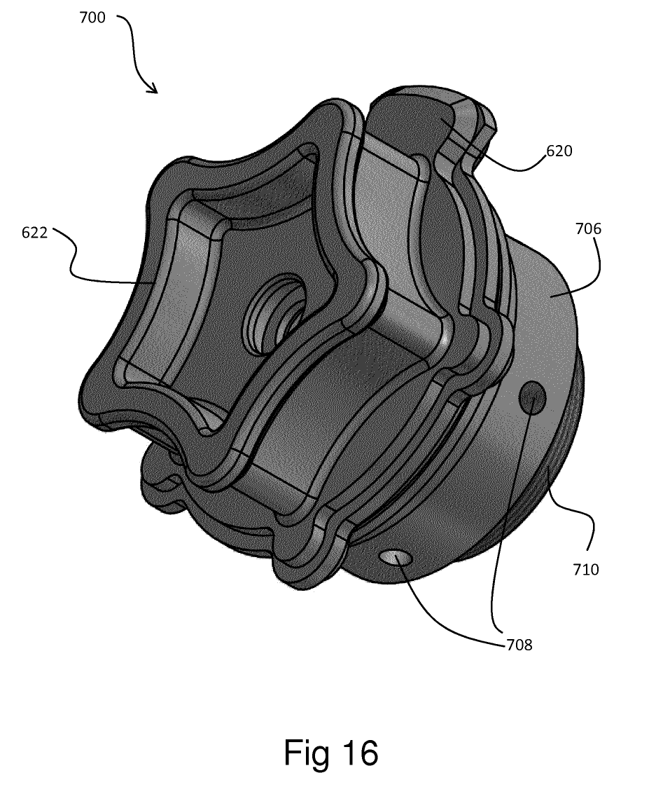

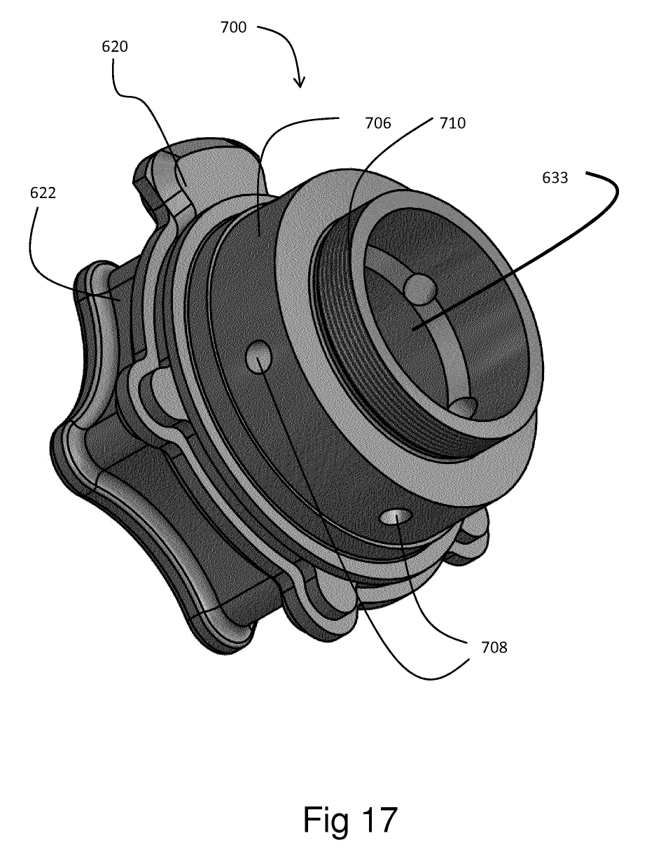

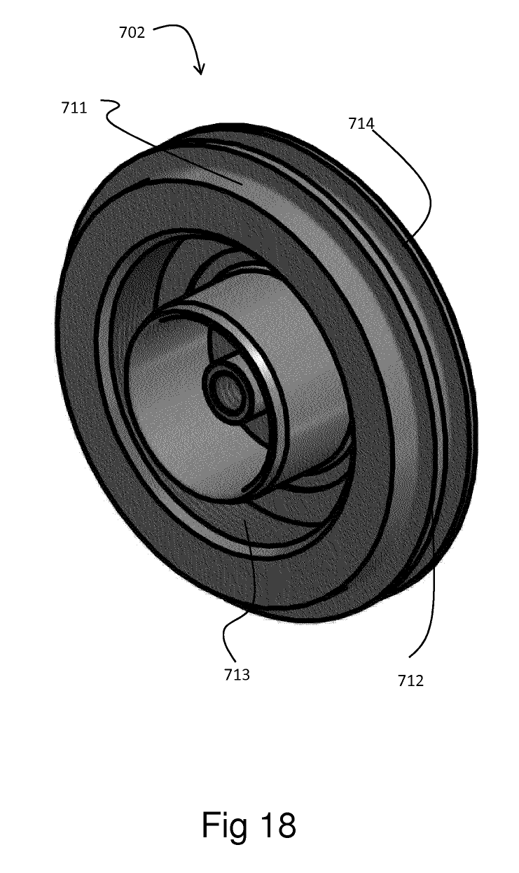

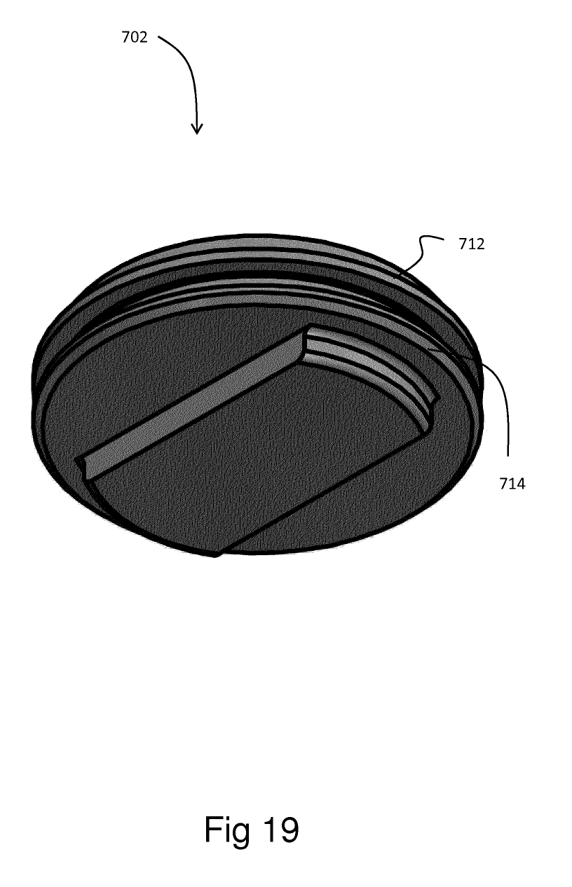

With reference to FIGS. 16 and 17, part of the housing of the control valve assembly is shown. As will be discussed in more detail below, the part shown in FIG. 16 forms a body 700 of the housing. The other part of the control valve assembly 507 is shown in FIGS. 18 and 19 and forms a cap 702. In this way, the body 700 and the cap 702 combine in a two piece construction to form the housing. The control valve (similar to the control valve referenced 25 in FIG. 2 and FIG. 3) is omitted for ease of reference to the drawings shown in FIGS. 16 to 18.

With reference to FIGS. 16 and 17, the body 700 includes the grip 622 and the peripheral flange 620 save the compliant ring, which compliant ring is attached to the body subsequently. The body 700 comprises an inlet 704 to the chamber 633, which chamber houses the control valve 25 (not shown). The chamber 633 is formed by a circumferential wall 706. A plurality of through-holes 708 are provided through the circumferential wall 706 between the chamber 633 and the cage 624 to form an outlet for fluidly linking the chamber 633 to the transfer line of the wheel hub (not shown). The through-holes extend radially outwardly and are equiangularly spaced apart. Since there are 6 through-holes, the degree of separation between adjacent holes is approximately 60 degrees.

The peripheral flange 620 in fact forms a flange for constraining axial movement of an O-ring 684a between itself and the cage 624 (FIG. 10).

At a side of the body 700 opposite the grip 670 is a throat 710. The throat has a smaller outer diameter than the annular wall, which outer diameter has a grooved surface for friction welding to the cap 702.

With reference to FIGS. 18 and 19, the cap 702 includes an annular wall 711 having the same outer diameter as the circumferential wall 706 of the body 700 (FIGS. 16 and 17). The inner diameter 713 is arranged to compliment the outer diameter of the throat 710 to aid with welding the body 700 to the cap 702.

The cap 702 includes inner 712 and outer 714 circumferential flanges extending radially outwardly. Inner flange 712 is arranged to constrain axial movement of an O-ring 684b (FIG. 10) and hold captive the O-ring 684b between itself and the cage 624 as shown in FIG. 10. A groove is provided intermediate the inner and outer flanges 712, 714 for constraining axial movement of a further O-ring 684c (FIG. 10).

These O-rings 684a, b, c (FIG. 10), are arranged to prevent air flow from passing intermediate the valve body 700 and the wheel hub, in use, as shown in FIG. 11.

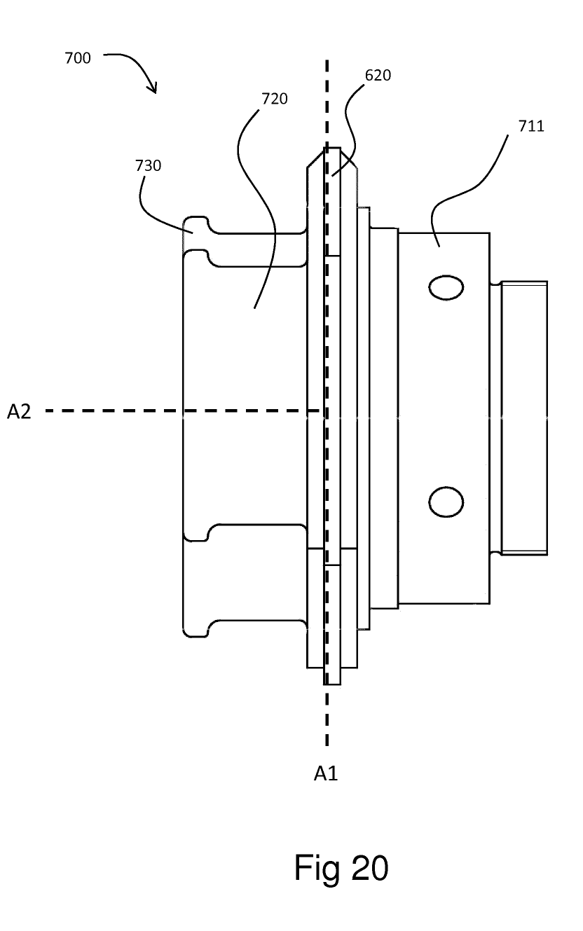

With reference to FIG. 20, the body is manufactured by molding. The broken lines in FIG. 20 represent interface boundaries between respective mold tools when fabricating the body. For instance, broken line A1 is situated along flange 620 indicating that axially separable mold tools meet at the flange 620. One mold tool is shaped to create the annular wall 711 and separates to the right away from the flange. The other mold tool is in fact formed from radially separable mold pieces arranged to meet each other at broken line A2. This opposing mold tool uses radial separation of its constituent mold pieces to facilitate molding the protrusion 730 at the grip. Due to the fabrication method employed, the body is formed as a substantially monolithic piece.

Each broken line A1, and A2, represent a flash-line, which flash-line results after separation of the mold tools. In this embodiment, there are two flash-lines. Flash-line A1 is a circumferential flash-line around the flange 620, which flash-line A1 is caused by the interface between the opposing mold tools. Flash-line A2 is an axial flash-line caused by interface between the radially separable mold parts. The rationale for fabricating the body in this way is due to the locality of the O-rings on the resultant body. Specifically, flash-lines are oriented to avoid contacting O-rings.

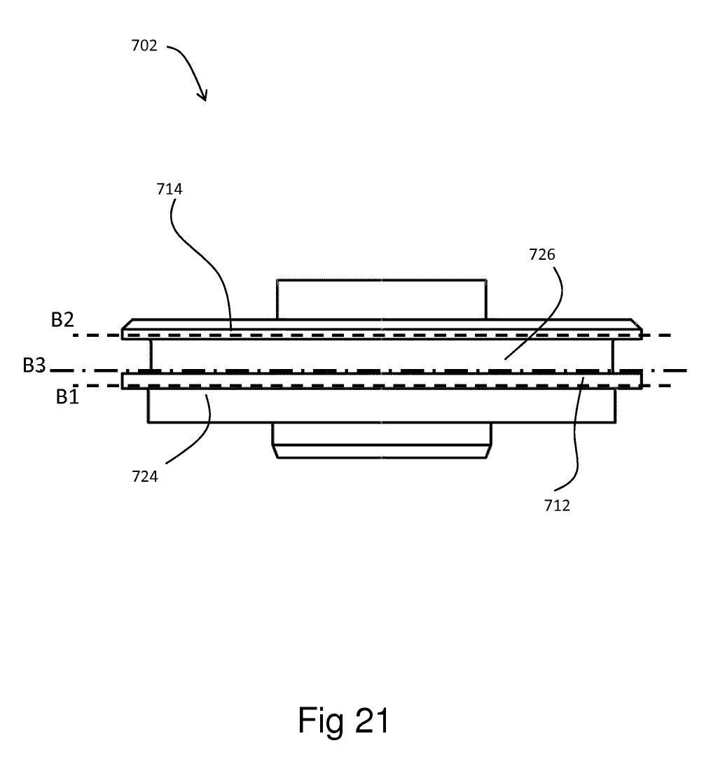

With reference to FIG. 21, the same principle of fabrication is employed in order to prevent flash-lines on the resultant cap coming in contact with the O-rings. As described above, the cap 702 includes two flanges, namely the inner and outer flanges 712, 714. Both flanges have a greater radial extent that the rest of the cap 702. Accordingly, the cap 702 is made in modular form with an inner module 724 and an outer module 726 each including a flange 712, 714 respectively. In this way, each module 724, 726 is fabricating by molding using opposing axially separable mold tools.

Similar to FIG. 20, broken lines B1 and B2 are shown in FIG. 21 to signify interfaces where opposing mold tools meet. These broken lines B1 and B2 are locations of resulting flash-lines on the cap 702 after molding. These flash lines B1 and B2 are circumferential flash-lines situated on the inner and outer flanges 712, 714, respectively. In this way, there are no flash-lines which come into contact with the O-rings.

After molding, the modules 724, 726 are attached by welding, specifically ultrasonic welding. A dot-dash line B3 is shown in FIG. 21 to represent the welding location.

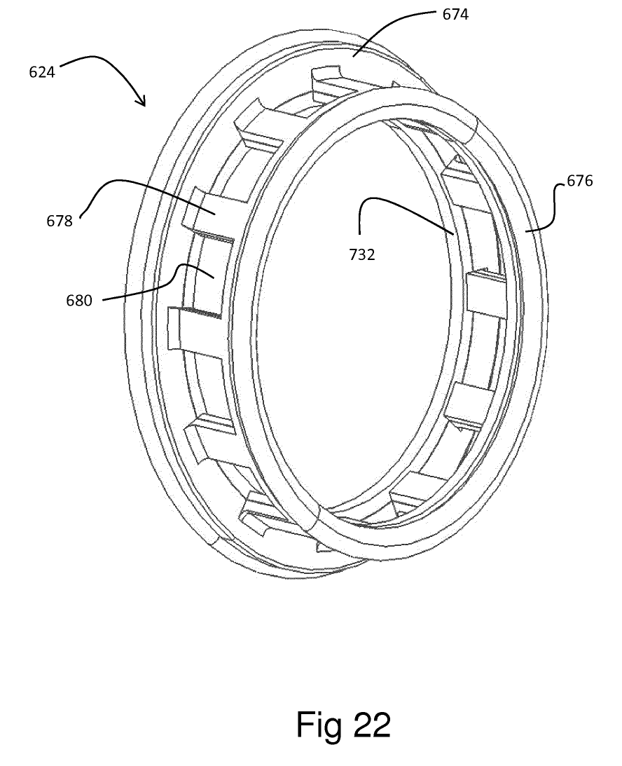

With reference to FIG. 22, the cage 624 is provided as an annular cage, which annular cage 624 includes a base member in the form of a base ring 674 and a secondary ring 676 joined together by a plurality of axial spokes 678. Intermediate the spokes 678 are a plurality of windows 680. The cage 624 supports an annular transfer line filter. The transfer line filter includes a plurality of transfer line filter elements 682 (FIG. 9) each received within a window 680 intermediate adjacent spokes 678. Specifically, air flowing from the transfer line to the control valve assembly is filtered by the transfer line filter elements 682, though reverse air flow may also be filtered during tire inflation for instance. Thus any debris in the tire cavity is precluded from entering the control valve assembly during tire deflation, further extending the service life of the control valve assembly and other components of the central tire inflation system. With further reference to FIGS. 9 and 10, the base ring 674 and secondary ring 676 abut opposing O-rings 684a,b to maintain a separation distance between them. The cage 624 thus serves two functions, firstly as an O-ring spacer and secondly as a filter holder so that the annular filter can be removed and replaced when clogged.

It can be seen from FIG. 22 that the base ring 674 of the case 624 includes a foot 732 extending radially inwardly. In this way, the spokes 678, and thus the filter elements 682, are separated from the circumferential wall 706 (FIG. 17) to create a cavity. In this way, if one filter element 682 in the vicinity of a through hole 708 (FIG. 17) becomes blocked, an air passage-way exists through the cavity to allow air to filter through one of the other filter elements 682.

The filter elements 682, and also the supply line filter 656 (FIGS. 14 and 15), are coated in a hydrophobic material. This prevents clogging and corrosion of the filters 682, 656. The hydrophobic material is a nano-material comprising silica. However, nano-composite materials, such as Manganese oxide polystyrene or zinc oxide polystyrene may also be used.

1-8. (canceled)

9. A method of manufacturing at least part of a housing for housing a control valve of a control valve assembly in a Central Tire Inflation System (CTIS) of a vehicle wheel assembly, the housing comprising a circumferential sealing surface for receiving at least one O-ring thereon, an outwardly extending circumferential flange for axially constraining said at least one O-ring, said least one O-ring arranged to seal hermetically the control valve assembly from a wheel hub within which the control valve assembly is removably mounted, the method comprising;
molding a first section of the part comprising the circumferential sealing surface using a mold tool;
molding a second section of the part using an opposing mold tool; and
axially separating the opposing mold tool from the mold tool to provide a circumferential flash-line on the housing,
and wherein said circumferential seal surface is free of flash lines.

10. The method of claim 9 comprising arranging the mold tool and opposing mold tool to locate the flash-line on the flange.

11. The method of claim 9 wherein at least part of the housing is manufactured in modular form, by:
fabricating a first module using the method steps of claim 9;
fabricating a second module using the method steps of claim 9; and
attaching the first module to the second module to provide respective first and second circumferential flash-lines on the housing.

12. The method of claim 9 wherein the first and second sections of the part are attached by welding.

13. The method of claim 12 wherein welding comprises ultrasonic welding.

14. The method of claim 9 wherein molding the second section comprises;
providing a mold tool having a mold piece and an opposing mold piece;
contacting the mold piece to the opposing mold piece for molding the second section; and
radially separating the opposing mold piece from the mold piece to provide an axial flash line on the housing extending from one side of the circumferential flash-line.

15. A housing for a control valve of a control valve assembly made using the method of claim 9.

16-18. (canceled)
